(19) United States
(12) Patent Application Publication
(10) Pub. No.: US 2004/0213098 A1
(43) Pub. Date: Oct. 28, 2004

(54) Focus-detecting emitter for a data storage device

(76) Inventor: Daniel R. Marshall, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/423,992

(22) Filed: Apr. 25, 2003

(51) Int. Cl. G11B 9/10; G11B 7/095

(52) U.S. Cl. 369/44.26; 369/101; 369/126

(57) ABSTRACT

A focus-detecting emitter for a data storage device is provided, such focus-detecting emitter including a first emission zone configured to selectively produce a first electron beam portion, and a second emission zone configured to selectively produce a second electron beam portion. The first electron beam portion generates a first spot on a storage medium and the second electron beam portion generates a second spot on the storage medium such that a position of at least one of the first spot and the second spot is indicative of a focus state of at least one of the first electron beam portion and the second electron beam portion.

### BACKGROUND

Various types of data storage devices are known, including optical storage devices, magnetic storage devices, electron data storage devices, etc. Electron data storage devices, in particular, include electron emitters, or emitting sources, and electron optics adapted to generate and focus electron beams. The electron beams may be used to both read and write data onto the storage medium in the storage device. Accordingly, electron data storage devices offer the ability to define relatively small recorded spots in comparison to the spots recorded using optical or magnetic storage devices. The smaller recorded spots facilitate a higher density of recorded information on the electron data storage device.

The size of the recorded spots may vary, depending on the angle of divergence of the emitted electrons and the size of the emitting area. The smaller the emitting area size and/or divergence angle, the smaller the achievable spot size and the higher the power density achievable in the focused spot. Therefore, by reducing the divergence angle, or the size of the emitting area, or both, it is possible to reduce the size of the recorded spots, and to increase the density of recorded spots on a storage medium. Such electron beams may be provided either by relatively large emitters that are collimated (having a very small divergence angle) or by very small emitters that have divergent beams.

To generate and read small recorded spots on a storage medium, the focus of the electron beam must be accurately maintained. Even small amounts of defocus may adversely affect the formation and reading of recorded spots on the storage medium. For example, a defocused beam may reduce the signal-to-noise ratio, making it difficult to accurately read data from or write data to the storage medium. Additionally, defocus may increase the size of the recorded spots, and may necessitate the use of a more powerful electron emitting source during the reading and/or writing process.

### SUMMARY

A focus-detecting emitter for a data storage device is provided, such focus-detecting emitter including a first emission zone configured to selectively produce a first electron beam portion, and a second emission zone configured to selectively produce a second electron beam portion. The first electron beam portion generates a first spot on a storage medium and the second electron beam portion generates a second spot on the storage medium such that a position of at least one of the first spot and the second spot is indicative of a focus state of at least one of the first electron beam portion and the second electron beam portion.

### BRIEF DESCRIPTION OF THE DRAWINGS

FIG. 1 is a somewhat schematic cross-sectional side view of an exemplary electron data storage device according to an embodiment of the present invention.

FIG. 2 is a schematic diagram illustrating operation of the exemplary electron data storage device shown in FIG. 1.

FIG. 3 is cross-sectional side view of a flat emitter suitable for use within the electron data storage device shown in FIG. 1.

FIG. 4 is a schematic diagram of a flat emitter having two electron emission zones according to an embodiment of the present invention.

FIG. 5 is a schematic diagram of a closed control loop for the emitter shown in FIG. 4.

FIG. 6 is a somewhat schematic illustration of an embodiment of a method of generating a focus signal using an emitter having two electron emission zones.

FIG. 7 is a flow diagram depicting a method of adjusting the focus of an electron beam in an electron beam storage device in accordance with an embodiment of the invention.

FIG. 8 is a flow diagram depicting a method of determining the focus of an electron beam in an electron storage device in accordance with an embodiment of the invention.

### DETAILED DESCRIPTION

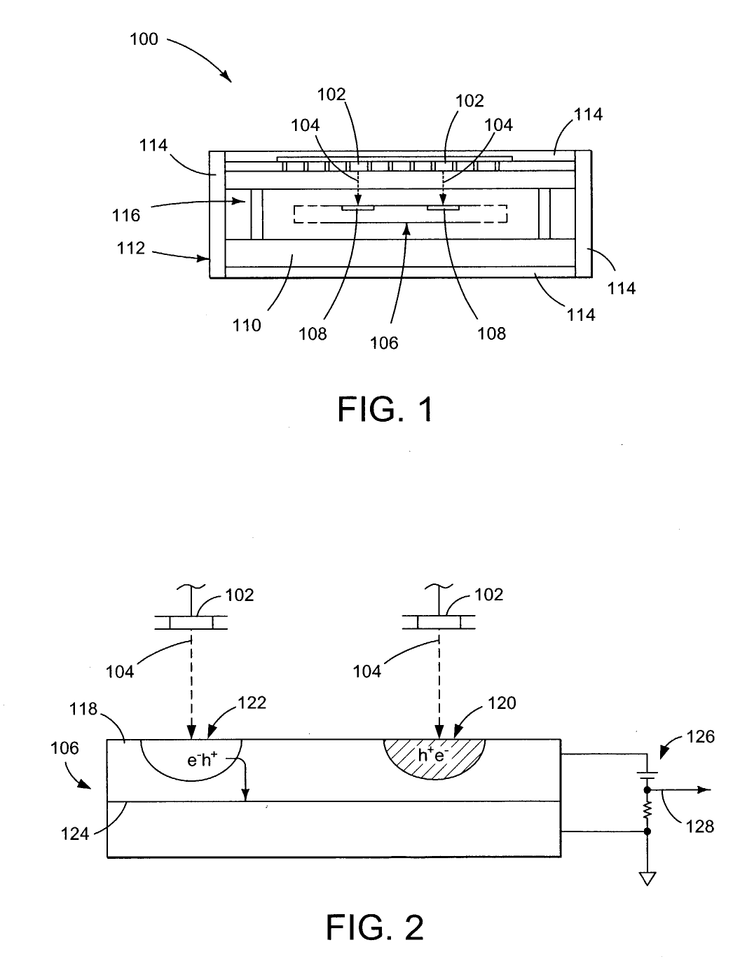

Referring initially to FIG. 1, an electron data storage device according to an embodiment of the present invention is shown generally at 100. Storage device 100 includes a plurality of electron emitters 102 configured to generate electron beams 104. The electron beams may be configured to bombard a receiving surface, such as storage medium 106. As described below, each electron beam may be focused and aligned with a data storage location or area 108 on storage medium 106.

A somewhat similar data storage device is described and disclosed, for example, in U.S. Pat. No. 5,557,596 to Gibson et al., the disclosure of which is hereby incorporated by reference. It is within the context of the exemplary storage device of FIG. 1 that the present apparatus and method are described. It should be noted, however, that the apparatus and method described herein may be used in a variety of other types and/or configurations of electron data storage devices where electron beams are used to read from and/or write data to a storage medium.

Briefly, in the depicted embodiment, a casing 112 typically is adapted to maintain storage medium 106 in at least a partial vacuum. Specifically, casing 112 may include a plurality of walls 114 that define an interior space 116. Walls 114 may be coupled together such that at least a partial vacuum may be maintained within interior space 116. It should be appreciated that different configurations for casing 112 are also contemplated.

As described above, each electron emitter 102 within interior space 116 may correspond to one or more data storage areas 108 provided on storage medium 106. Where each electron emitter corresponds to a number of storage areas, storage device 100 typically is adapted to scan, or otherwise effect, relative movement between emitters 102 and storage medium 106. Exemplary storage device 100 may include a micromover 110, which may scan or move the storage medium 106 with respect to the electron emitters. For example, micromover 110 may be adapted to move storage medium 106 to different positions so that electron emitters 102 may be aligned with different storage areas. Alternatively, a micromover may be adapted to move the electron emitters relative to the storage area such that the electron beams scan across the storage medium. Any suitable micromover may be used to obtain relative motion between electron emitters 102 and storage medium 106. It should be understood that relative movement may alternatively be obtained by displacing both the electron emitters and the storage medium.

Electron emitters 102 are configured to emit electron beam currents, also referred to herein as electron beams, such that the electron beams selectively bombard storage areas 108 on storage medium 106. By bombarding the storage medium, focused spots may be formed on the storage medium. The electron emitters suitable for use with storage device 100 produce electron beams narrow enough to achieve the desired spot density on storage medium 106.

The electron beams produced via the electron emitters may be used to read or write data. Writing may be accomplished by temporarily increasing the power density of the electron beam currents to modify the surface state of the storage area. Reading may be accomplished by detecting the effect of the storage area on the electron beams, or the effect of the electron beams on the storage area. For example, a data storage area in a first state may represent a “1” bit, and a data storage area in a second state may represent a “0” bit. It is further possible to modify the data storage areas such that they represent more than two bits. The modifications to the storage areas may be permanent or reversible (temporary). A permanently modified storage medium may be suitable for write-once-read-many memory (WORM).

In some embodiments, storage medium 106 may be constructed of a material having a surface state that may be selectively changed from crystalline to amorphous by electron beams. To change from the amorphous to the crystalline, the beam power density may be increased and then slowly decreased. This increase/decrease heats the amorphous area and then slowly cools it so that the area has time to anneal into its crystalline state. To change from the crystalline to amorphous, the beam power density may be increased to a high level and then rapidly reduced.

As an example, FIG. 2 illustrates one embodiment that may be used to read from and write data to the storage medium. Specifically, FIG. 2 illustrates a storage device incorporating a diode structure 118 that may be used to determine the surface state of storage areas 120, 122. In the depicted embodiment, diode structure 118 may be a pn junction, a Schottky barrier or any other type of suitable electronic valve.

In the depicted embodiment, the storage medium is arranged as a diode having two layers. By way of example, one of the layers is p-type and the other is n-type. The storage medium may be connected to an external circuit that reverse-biases the storage medium. With this arrangement, data may be stored by locally altering the surface state of a diode in such a way that the collection efficiency for minority carriers generated near an altered region or written area 120 is different from that of an unaltered region or unwritten area 122. It should be noted that charge carriers (holes and electrons) are present in the storage medium. The more abundant charge carriers are called majority carriers; the less abundant charge carriers are called minority carriers. In n-type semiconductor material, electrons are the majority carriers and holes are the minority carriers. In p-type semiconductor material, the electrons are the minority carriers and the holes are the majority carriers.

The collection efficiency for minority carriers may be defined as the fraction of minority carriers generated by the electrons that are swept across the diode junction 124 when it is biased by an exemplary external circuit 126. The minority carriers thus cause a signal current 128 to flow in the external circuit. The magnitude of the current resulting from the minority carriers typically depends on the state of the storage area.

In operation, electron emitters 102 emit narrow beams of electrons 104 onto the surface of storage medium 106. The incident electrons excite electron-hole pairs (represented by e-h+ in FIG. 2) near the surface of the diode. As used herein, a hole is an electric charge carrier with a positive charge, equal in magnitude, but opposite in polarity, to the charge on an electron. Because the medium is reverse-biased by the external circuit, the minority carriers generated by the incident electrons may be swept toward diode junction 124. Electrons that reach diode junction 124 generally are swept across the junction. In other words, minority carriers that do not recombine with majority carriers before reaching the junction generally are swept across the junction, causing a current to flow in external biasing circuit 126.

Writing onto storage medium 106 may be accomplished by increasing the power density of the electron beam 104 enough to locally alter some property or properties of the diode in the vicinity of the incident electron beam. The alteration affects the number of minority carriers swept across the junction 124 when the same area is irradiated with lower power density “read” electron beams. For example, the recombination rate in a written area 120 may be increased relative to an unwritten area 122 so that the minority carriers generated in the written area have an increased probability of recombining with majority carriers before they have a chance to reach and cross junction diode 124. Hence, a smaller current may flow in the external circuit 126 when the read electron beams are incident upon a written area than when the beams are incident upon an unwritten area. Conversely, it is also possible to start with a diode structure with a high recombination rate, and to write by locally reducing the recombination rate. The resulting current constitutes an output signal 128 which may indicate a stored data bit. Although described in reference to a diode structure, it should be appreciated that other methods may be used to read from and write data to the storage medium, including, but not limited to, collecting and measuring backscattered or secondary electrons.

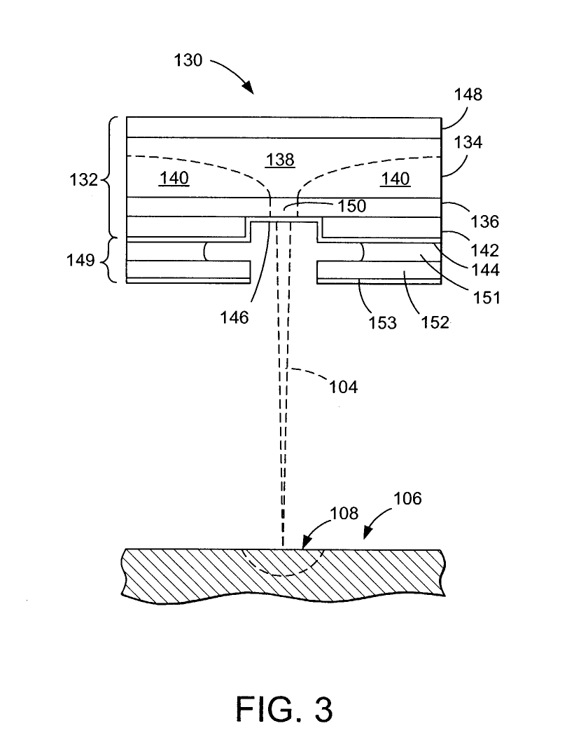

FIG. 3 illustrates an exemplary flat emitter 130 having an electron emission structure, indicated generally at 132. Although the present flat emitter configuration is described in detail below, it should be appreciated that other configurations for flat emitter 130 are possible.

Flat emitter 130 may include an n++ semiconductor substrate 134, formed of a material such as silicon, and a semiconductor layer 136. Substrate 134 may be fabricated such that it includes a volcano-like, funnel-like, or nozzle-like active region 138. Active region 138 may be surrounded by an isolation region 140 that limits the area from which the active region can emit electrons. In addition to limiting the geometry of the active region, in some embodiments, the isolation region may isolate the active region from neighboring active regions. However, in other embodiments, it will be understood that the active regions of contiguous electron emitters may be connected together.

Flat emitter 130 also includes an emission region 142 formed on semiconductor layer 136 of substrate 134. Emission region 142 may be used to supply voltage to semiconductor layer 136. In addition to the emission region, flat emitter 130 includes a conductive layer 144 that covers emission region 142 and a portion of semiconductor layer 136. The conductive layer provides an electrical contact over an emission surface 146 and enables an electric field to be applied across the emission surface.

In some embodiments, emitter 130 includes a back contact 148 formed on the substrate on a side opposite that on which the semiconductor layer is formed. When provided, the back contact establishes an equipotential surface for internal fields in the semiconductor substrate.

During operation, different potentials may be applied (e.g., with on- or off-chip drivers) across substrate 134 via emission region 142 and back contact 148. The resulting emission region voltage causes electrons to be injected from active region 138 of substrate 134 into region 150 of semiconductor layer 136. The electrons then may be emitted from emission surface 146. This emission results in an electron beam 104 that impinges a selected target location 108 on storage medium 106.

Electron optics or other focusing structures 149 (such as a focusing electrodes or other beam-focusing mechanisms) may be used to focus the electron beams onto storage medium 106. For illustrative purposes only, focusing structure 149 may include a focusing electrode 152 (also referred to herein as a lens electrode). Focusing electrode 152 may be formed so as to define an aperture through which electron beams can pass.

In some embodiments, focusing electrode 152 may be spaced some distance from emission surface 144 by insulating layer 151. Thus, insulating layer 151 isolates the emission electrode 140 from focusing electrode 152. In other embodiments, the focusing electrode may be in close proximity to emission surface 144. Like conductive layer 142, conductive layer 153 provides a contact over the corresponding electrode such that an electric field can be applied thereto. Although only one focusing electrode is illustrated, it should be appreciated that any number of focusing electrodes may be employed to focus the electron beam.

In operation, a potential is applied to focusing electrode 152 thereby generating an electric field. Application of an electric field to the electron beam, results in the application of an electric charge to the beam. The beam reacts to the charge, moving in response to the applied electric field. The resulting electric field may be used to focus the emitted electrons in the electron beam. This focus may be adjusted by varying the potential applied to the focusing electrode. A voltage may also be applied to storage medium 106 to accelerate and/or decelerate the emitted electrons, or to aid in focusing the electron beam.

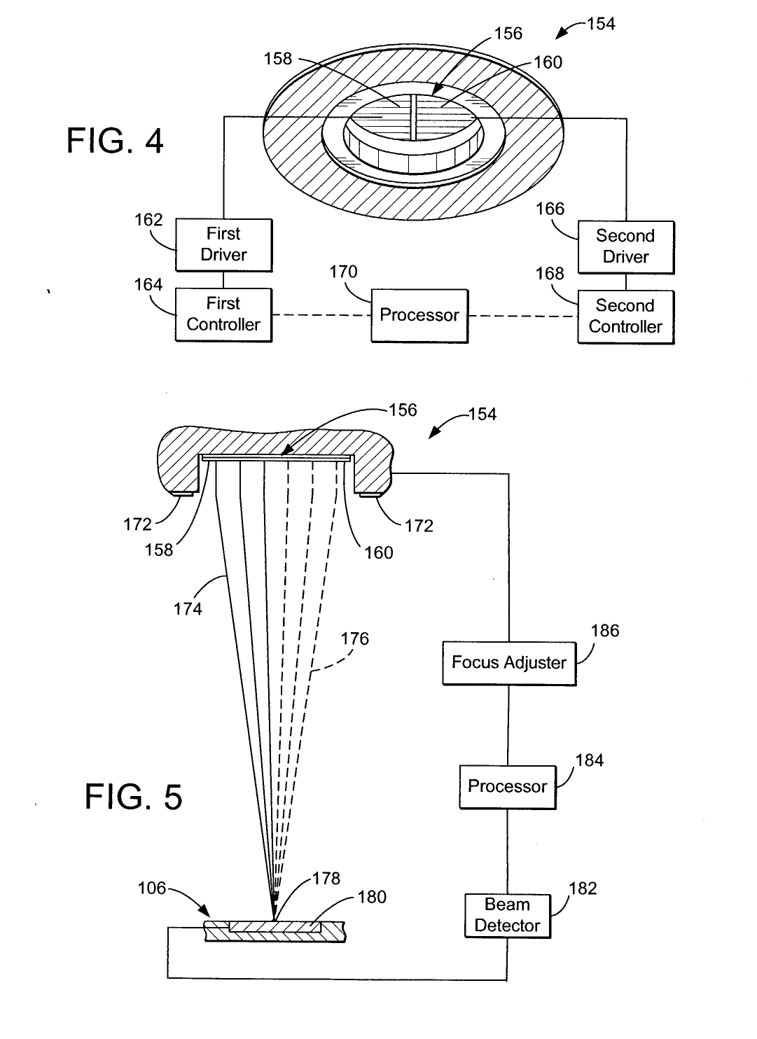

An embodiment of a focus-detecting emitter is illustrated in FIG. 4. Although illustrated as a flat emitter, other suitable emitters may be used as a focus-detecting emitter. For example, it should be appreciated that two or more point emitters (also referred to as tip emitters) may function as a focus-detecting emitter. Point emitters typically are cone-shaped and have emitter tips from which narrow, focused beams of electrons may be emitted. Where two or more of such point emitters, or other suitable emitters, are focused on the same spot, they may be considered a focus-detecting emitter. Thus, as described in more detail below, two point emitters in combination may function as a first emission zone and a second emission zone, respectively generating first and second electron beam portions.

As illustrated in FIG. 4, flat emitter 154 may operate as a focus-detecting emitter. Flat emitter 154 emits a collimated beam and includes an electron emission structure, indicated generally at 156, which may be similar to the electron emission structure 132 described in relation to FIG. 3. Electron emission structure 156 comprises a conductive layer that substantially covers the emission region. The conductive layer provides an electrical contact over the emission surface such that an electric field may be applied across the emission surface to stimulate emission of electrons. In the present embodiment, the conductive layer is split into a plurality of segments, also referred to herein as emission zones 158, 160. Each emission zone may be configured to selectively emit a portion of the total emittable electron beam.

Flat emitter 154 may include a first emission zone configured to be selectively operated to produce a first electron beam portion and a second emission zone configured to be selectively operated to produce a second electron beam portion. The first electron beam portion and the second electron beam portion may be collimated and parallel at their respective sources. A focusing lens, or a plurality of focusing lenses having common axes, may be used to simultaneously focus the beam portions as they are directed onto the storage medium. If the parallel beam portions are fully in focus they will be substantially superimposed to form a single illuminated spot on the storage medium. The position of focus is also referred to herein as the region of focus. Away from the region of focus, the separate beams will be identifiably distinct. By measuring the electrical signal produced by the first and second electron beam portions, the focus state of the composite beam may be identified. Identification of the focus state of the beam may enable the focus to be corrected, thereby enhancing the reading and writing conditions on the storage medium.

The electrical signal produced by the electron beam portions may be detected in any suitable manner. For example, and as schematically illustrated in FIG. 5, storage medium 106 may include a sensitized region 180 linked to a beam detector (or spot detector) 182 coupled to a processor 184. Focus information may be transmitted from the spot detector to the processor in the form of an electrical signal. For example, a focus signal may be generated by the spot detector and used to identify the focus state of the electron beam, i.e., whether the electron beam is in focus (best focus), under-focused or over-focused. The focus signal may be averaged or otherwise manipulated to provide information as to the current state of focus of the electron beam portions.

Referring back to FIG. 4, in the illustrated embodiment, the conductive layer is split into two electrically-isolated, semicircular segments to produce two semicircular emission zones, 158 and 160. Emission zones 158 and 160 are used to generate an electrical signal that may be used to determine the state of focus of the electron beam. It should be appreciated that the conductive layer may be split into any number of emission zones and may be in any suitable geometric arrangement.

Each emission zone may be connected to an independent driver and/or controller. For example, first emission zone 158 may be connected to a first driver 162 and/or a first controller 164, and second emission zone 160 may be connected to a second driver 166 and/or a second controller 168. The drivers power the emission zones such that the emission zones generate a portion of an electron beam. Typically, the controllers control the drivers and it should be appreciated that the drivers may be incorporated within the controllers. In some embodiments, a single processor 170 may manage both first controller 164 and second controller 168.

Processor 170 manages each of the emission zones such that each emission zone may be alternately switched on and off to produce time-interleaved first and second electron beam portions. By determining the position of the spots produced by the first and second electron beam portions, it is possible to determine whether the emitter is in focus. Specifically, if the position of the spots shifts laterally when the spot produced by a second electron beam portion replaces the spot produced by the first electron beam portion, a focus error may be identified.

If there is no lateral shift in the position of the spots, the emitter may be identified as being fully in focus. In another embodiment, the emission zones may have their emitted electron beams fractionally modulated. For example, the electron beams may be gradually simultaneously and oppositely varied, so that the total beam power remains constant, while the separate zones increase or decrease their outputs differentially by some fraction of the range from “on” to “off”. This produces a beam that is spatially modulated everywhere but at the focused spot, while maintaining constant power for best reading performance. Such a method produces a modulation of the focus signal that varies in phase and amplitude according to whether the medium is on the near- or far-side of focus.

FIG. 5 further illustrates the use of emission zones 158 and 160 to generate a dynamic focus signal that may provide real-time feedback to the emitter to correct a focus error. Specifically, emitter 154 may include an electron emission structure 156 having two semi-circular emission zones, first emission zone 158 and second emission zone 160. At least one focusing lens 172 may encircle the electron beam portions, thereby providing a mechanism to control the focus of the electron beam portions on storage medium 106.

In some embodiments, the emission zones may be arranged so that the split between them is aligned perpendicularly to the direction of travel of a moving electron beam or storage medium. Modulation of the separate emission zones during scanning produces real-time information regarding focus of the spot.

As described above, each emission zone 158 and 160 may be individually switched on and off. In FIG. 5, first emission zone 158 is illustrated in an on-mode, producing electron beam portion 174. Dashed lines 176 indicate the electron beam portion that is produced by second emission zone 160 when it is switched on. When in-focus, both electron beam portion 174 and electron beam portion 176 may be focused by focusing lens 172 to produce a spot 178 on storage medium 106. Thus, electron emitter 154 is configured to generate two independently-operable beams of electrons (referred to herein as beam portions), both of which may be passed through the same focusing lens to form a substantially aggregate spot at best focus. When out-of-focus, the beam may produce two distinct spots on the storage medium.

As described above, beam detector 182 detects the electrical signal generated by the bombardment of the beam portions on the storage medium. Processor 184 interprets the electrical signal identifying whether the electron beam portions are in-focus or out-of-focus from beam detector 182.

Processor 184 communicates with focus adjuster 186, such as a focus servo-mechanism, to adjust the focus of focusing lens 172 based on focus signal. Focus adjuster 186 may be coupled with, or incorporated within the focusing lens. For example, focus adjuster 186 alters the voltage applied to the focusing lens, altering the effective electric field, and changing the deflection of the electrons in the electron beam portions. Changes in the electric field, and the deflection of the emitted electrons, operate to correct the focus of the electron beam portions and thus, of the electron beam. Such a system produces a dynamic closed-loop correction of focus in an electron data storage device. It should be appreciated that other suitable detection and adjustment techniques may be used to detect and/or adjust the position of the spots on the storage medium, or focus signal generated from the electron beam portions.

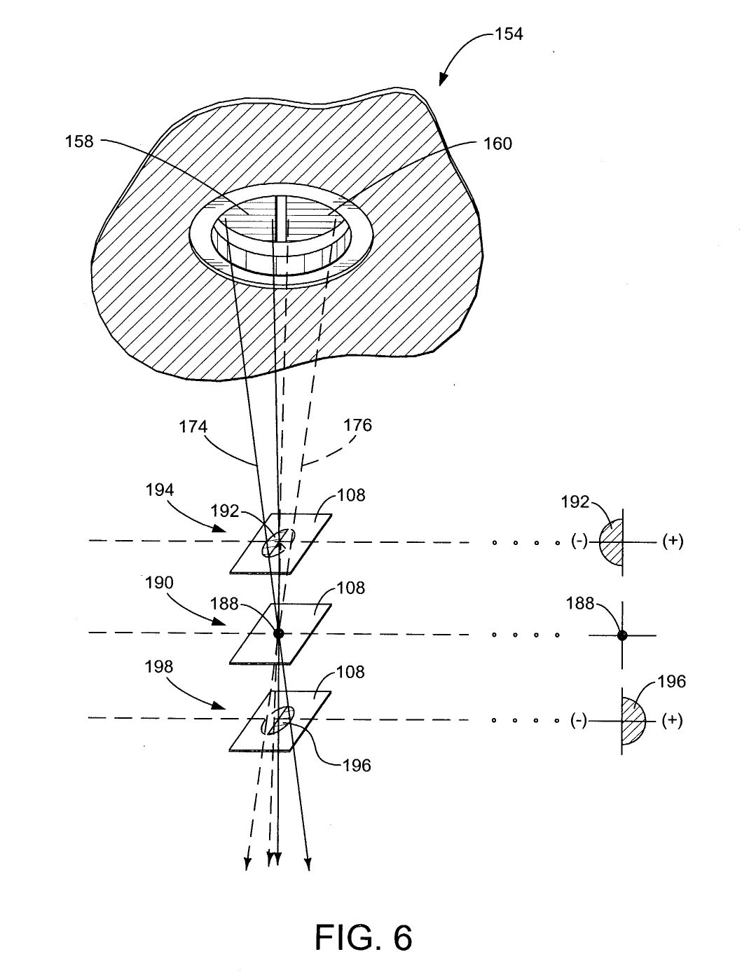

FIG. 6 illustrates exemplary images produced by an electron beam on the storage medium when in and out of focus. The current system adapts Foucault's classical knife-edge test for use within an electron storage device. In the current system, the emission zones simulate a virtual knife-edge. Thus, electron beam portion 174 generated via first emission zone 158 produces a first spot on storage medium 108. Similarly, electron beam portion 176 (shown in dashed lines) generated by second emission zone 160 produces a second spot on storage medium 108. The change in the position of the illuminated spot or the corresponding change in the phase of a measured signal produced by electron beam portions 174 and 176 is used to determine whether the emitter is in focus.

For example, in some embodiments the overall electron beam is modulated by simultaneously and oppositely varying the emission from each emission zone so as to maintain a constant total beam current. If the spot is in focus (shown at 190), there will be little or no perceptible variation in the focus signal as the beam is modulated. In contrast, if the spot is out of focus (shown at 194 and 198), then there is a perceptible variation in the focus signal as the beam is modulated. Once such an out-of-focus condition is noted, the task of determining whether the beam portions are under-focused or over-focused remains.

As used herein, an under-focused beam portion nominally would produce a spot nearer to the electron emitter than the focal point (e.g., as where the focal length is longer than the distance between the electron emitter and the storage medium). Such an under-focused beam portion may produce a spot, for example, as shown at 192 in FIG. 6. An over-focused beam portion, as used herein, nominally would produce a spot farther from the electron emitter than the focal point (e.g., as where the focal length is shorter than the distance between the electron emitter and the storage medium). Such an over-focused beam portion may produce a spot, for example, as shown at 196 in FIG. 6.

It will be appreciated that it is possible to determine whether an out-of-focus beam portion is under-focused or over-focused based on the position of the resulting spot on the storage medium. For example, beam portion 174, if under-focused may produce a spot 192 to the left of the indicated central axis. Conversely, beam portion 174 if over-focused, may produce a spot 196 to the right of the indicated central axis. Such positional change may be considered to represent a phase shift, which in turn, may be evident in the phase of the resulting focus signal. In the depicted illustrations, for example, it will be appreciated that a modulating beam for spots above (or nearer) the electron beam emitter than nominal in-focus spot 188 will be of opposite phase (180 degrees out-of-phase) relative spots below (or farther from) the electron beam emitter than nominal in-focus spot 188.

The focus of the electron beam portions may change over time. For example, the stability of the emitter, the stability of the behavior of the focusing electrodes, the stability of the bias voltages, and the spacing between the emitter and the storage medium all may change over time. By providing a dynamic focus check, the focus can be adjusted to accommodate changes to the device, including, but not limited to, changes in the stability of the emitter, the focusing electrodes, the bias voltages, etc. Similarly, any changes to the focus from external disturbances, such as temperature changes or vibrations, may be recognized and corrected, thereby increasing the lifetime of the device.

As described above, detection of a focus error may be communicated to the focus adjuster, which may change the focus of the electron beam by altering the voltage applied to the focusing lens (e.g. focusing electrode(s)), and thus, altering the effective electric field which directs deflection of electrons in the electron beam. By using such a closed loop system, the focus of the electron beam may be continually adjusted.

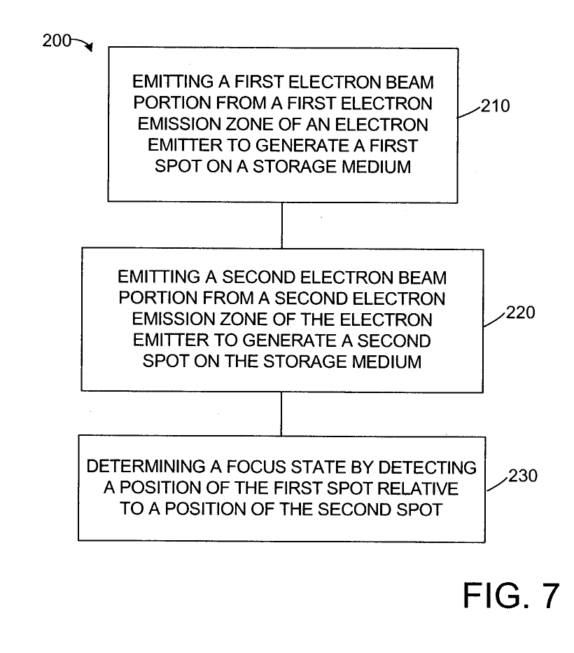

Referring to FIG. 7, a method of adjusting the focus of an electron beam in an electron data storage device is shown generally at 200. As indicated, the method includes emitting a first electron beam portion from a first electron emission zone of an electron emitter to generate a first spot on a storage medium (at 210), emitting a second electron beam portion from a second electron emission zone of the electron emitter to generate a second spot on the storage medium (at 220), and determining a focus state by detecting a position of the first spot relative to a position of the second spot (at 230). The method also may include generating a focus signal based on the position of the first spot relative to the position of the second spot and adjusting the focus of the electron beam based on the focus signal, wherein adjusting the focus includes applying an electric field to at least one of the first electron beam portion and the second electron beam portion to deflect electrons in the respective electron beam portion thereby changing the focus of the at least one of the first electron beam portion and the second electron beam portion.

In one embodiment, the method involves modulating between generating the first spot and generating the second spot. Determining the focus thus may include comparing an electrical signal produced when the first spot is generated and an electrical signal produced when the second spot is generated. Alternatively, determining the focus state may include determining that both the first electron beam portion and the second electron beam portion is in focus, determining that at least one of the first electron beam portion and the second electron beam portion is out of focus, determining that at least one of the first electron beam portion and the second electron beam portion is under focused, or determining that at least one of the first electron beam portion and the second electron beam portion is over focused.

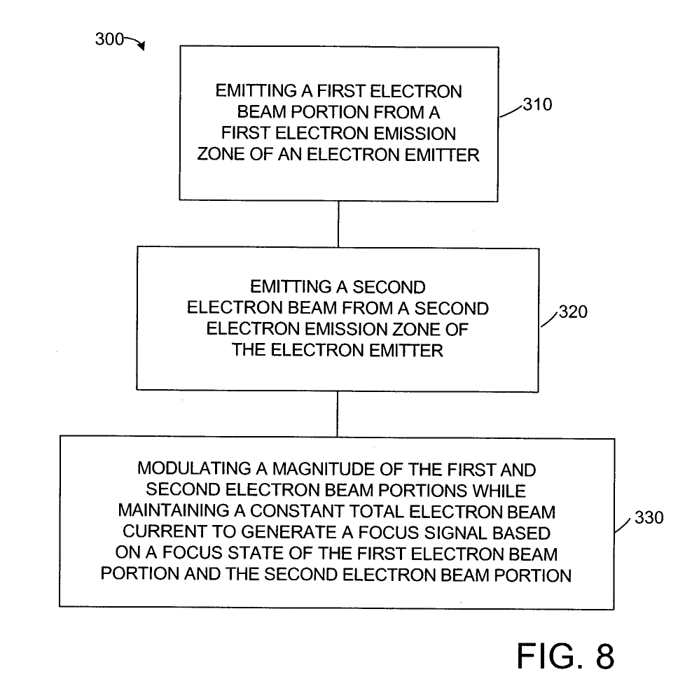

FIG. 8 depicts a method of determining the focus of an electron beam in an electron storage device generally at 300. The method includes emitting a first electron beam portion from a first electron emission zone of an electron emitter (at 310), emitting a second electron beam from a second electron emission zone of the electron emitter (at 320), and modulating a magnitude of the first and second electron beam portions while maintaining a constant total electron beam current to generate a focus signal based on a focus state of the first electron beam portion and the second electron beam portion (at 330). Method 300 may further include determining whether one of the first electron beam portion and second electron beam portion is in focus, under focused or over focused, adjusting the focus of at least one of the first electron beam portion and the second electron beam portion based on the determination of whether one of the first electron beam portion and second electron beam portion is in focus, under focused or over focused.

Referring still to method 300, it is noted that determining whether one of the first electron beam portion and second electron beam portion is in focus may include determining whether there is a variation in the signal produced upon modulation of the magnitude of the first electron beam portion and the second electron beam portion. Adjusting the focus of at least one of the first electron beam portion and the second electron beam portion may include altering the electric field on the electron beam emitted from the electron emitter thereby causing electrons in the respective electron beam portion to be deflected.

What is claimed is:

1. A focus-detecting emitter for a data storage device, the focus-detecting emitter comprising:
a first emission zone configured to selectively produce a first electron beam portion; and
a second emission zone configured to selectively produce a second electron beam portion;
wherein the first electron beam portion generates a first spot on a storage medium and the second electron beam portion generates a second spot on the storage medium, position of the first spot with respect to the second spot being indicative of a focus state of the electron beam portions where a position of at least one of the first spot and the second spot is indicative of a focus state of at least one of the first electron beam portion and the second electron beam portion.

2. The focus-detecting emitter of claim 1, wherein the position of the first spot is substantially coincident with the position of the second spot such that the first electron beam portion and the second electron beam portion are in-focus.

3. The focus-detecting emitter of claim 1, wherein the position of the first spot is spaced from the position of the second spot such that at least one of the first electron beam portion and the second electron beam portion is out-of-focus.

4. The focus-detecting emitter of claim 3, wherein the position of the first spot is spaced in a first direction from the second spot such that the first electron beam portion is under-focused.

5. The focus-detecting emitter of claim 3, wherein the position of the first spot is spaced in a second direction such that the first electron beam portion is over-focused.

6. The focus-detecting emitter of claim 1, wherein a lateral shift in the position of either spot indicates that a corresponding electron beam portion is out of focus.

7. The focus-detecting emitter of claim 1, wherein the emitter is a flat emitter.

8. An electron data storage device, comprising:
a storage medium; and
at least one electron emitter adapted to emit an electron beam, the emitter having a first emission zone configured to selectively produce a first electron beam portion and a second emission zone configured to selectively produce a second electron beam portion;
wherein the first electron beam portion generates a first spot on the storage medium and the second electron beam portion generates a second spot on the storage medium, position of the first spot with respect to the second spot being indicative of a focus state of the electron beam portions where a position of at least one of the first spot and the second spot is indicative of a focus state of at least one of the first electron beam portion and second electron beam portion.

9. The electron data storage device of claim 8, wherein the emitter is configured to modulate between production of the first electron beam portion and the second electron beam portion.

10. The electron data storage device of claim 8, wherein the position of the first spot is substantially coincident with the position of the second spot such that the first electron beam portion and the second electron beam portion are in focus.

11. The electron data storage device of claim 8, wherein the position of the first spot is spaced from the position of the second spot such that the electron emitter is out of focus.

12. The electron data storage device of claim 11, wherein the position of the first spot is spaced in a first direction from the second spot such that the first electron beam portion is under-focused.

13. The electron data storage device of claim 11, wherein the position of the first spot is spaced in a second direction such that the first electron beam portion is over-focused.

14. The electron data storage device of claim 8, wherein a lateral shift in the position of the first spot indicates that the first electron beam portion is out-of-focus.

15. The electron data storage device of claim 8, further comprising a focusing lens configured to focus the first electron beam portion and the second electron beam portion onto the storage medium.

16. The electron data storage device of claim 8, further comprising a spot detector configured to generate a focus signal based on the position of the first spot with respect to the position of the second spot.

17. The electron data storage device of claim 16, wherein the focus signal is an electrical signal including information regarding the focus state of at least one of the first electron beam portion and the second electron beam portion.

18. The electron data storage device of claim 16, wherein the storage medium includes a sensitized region coupled to the spot detector, the sensitized region configured to identify the position of the first spot and the position of the second spot.

19. The electron data storage device of claim 16, further comprising a focus adjuster configured to adjust the focus of the electron beam portion based on the focus signal.

20. A method of adjusting the focus of an electron beam in an electron data storage device, the method comprising:
emitting a first electron beam portion from a first electron emission zone of an electron emitter to generate a first spot on a storage medium;
emitting a second electron beam portion from a second electron emission zone of the electron emitter to generate a second spot on the storage medium;
determining a focus state by detecting a position of the first spot relative to a position of the second spot.

21. The method of claim 20, further comprising generating a focus signal based on the position of the first spot relative to the position of the second spot.

22. The method of claim 21, further comprising adjusting the focus of the electron beam based on the focus signal.

23. The method of claim 22, wherein adjusting the focus includes applying an electric field to at least one of the first electron beam portion and the second electron beam portion to deflect electrons in the respective electron beam portion thereby changing the focus of the at least one of the first electron beam portion and the second electron beam portion.

24. The method of claim 20, further comprising modulating between generating the first spot and generating the second spot.

25. The method of claim 20, wherein determining a focus state includes comparing an electrical signal produced when the first spot is generated and an electrical signal produced when the second spot is generated.

26. The method of claim 20, wherein determining a focus state includes determining that both the first electron beam portion and the second electron beam portion are in-focus.

27. The method of claim 20, wherein determining a focus state includes determining that at least one of the first electron beam portion and the second electron beam portion is out-of-focus.

28. The method of claim 20, wherein determining a focus state includes determining that at least one of the first electron beam portion and the second electron beam portion is under-focused.

29. The method of claim 20, wherein determining a focus state includes determining that at least one of the first electron beam portion and the second electron beam portion is over-focused.

30. A method of determining the focus of an electron beam in an electron storage device, the method comprising:
emitting a first electron beam portion from a first electron emission zone of an electron emitter;
emitting a second electron beam from a second electron emission zone of the electron emitter;
modulating a magnitude of the first and second electron beam portions while maintaining a constant total electron beam current to generate a focus signal based on a focus state of the first electron beam portion and the second electron beam portion.

31. The method of claim 30, further comprising determining whether one of the first electron beam portion and second electron beam portion is in-focus, under-focused or over-focused.

32. The method of claim 30, further comprising adjusting the focus of at least one of the first electron beam portion and the second electron beam portion based on a determination of whether one of the first electron beam portion and second electron beam portion is out-of-focus.

33. The method of claim 32, wherein adjusting the focus of at least one of the first electron beam portion and the second electron beam portion includes altering the electric field on the electron beam emitted from the electron emitter thereby causing electrons in the respective electron beam portion to be deflected.

34. The method of claim 31, wherein determining whether one of the first electron beam portion and second electron beam portion is in focus, includes determining whether there is a variation in the signal produced upon modulation of the magnitude of the first electron beam portion and the second electron beam portion.

35. An electron data storage device, comprising:
means for storing data;
means for generating a first electron beam portion to form a first spot on the means for storing data;
means for generating a second electron beam portion to form a second spot on the means for storing data; and
means for determining a focus state for at least one of the first electron beam portion and the second electron beam portion by determining a position of the first spot relative to a position of the second spot.

36. The electron data storage device of claim 35, further comprising a means for adjusting at least one of the first and second electron beam portions so that a resulting composite beam is in-focus.
